(19) United States
(12) Patent Application Publication
(10) Pub. No.: US 2006/0132852 A1
(43) Pub. Date: Jun. 22, 2006

(54) Controlling photofinishing using ranked data frames

(76) Inventors: Steven C. Sitter, Fairport, NY (US); John R. Fredlund, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/021,127

(22) Filed: Dec. 22, 2004

(51) Int. Cl. H04N 1/23

(52) U.S. Cl. 358/302

(57) ABSTRACT

In a photographic processing method, an image unit is received. The image unit has a plurality of printable image frames including first and second data frames and a plurality of non-data frames. The data frames each having different, alternative fulfillment information. A bitstream is generated of the image frames. The bitstream includes a chronology or other ranking of the data frames. The data frames are extracted from the bitstream. The data frames are read. The highest ranked of the data frames is determined. Fulfillment of the non-data frames is provided responsive to the alternative fulfillment information of the highest ranked of the data frames.

### CROSS REFERENCE TO RELATED APPLICATIONS

Reference is made to commonly assigned, co-pending U.S. patent application Ser. No. ______, [Attorney Docket No. 87052], entitled: CONTROLLING PHOTOFINISHING USING DATA FRAME DESIGNATED PHOTOFINISHING SUBCHANNELS, filed Dec. 22, 2004, in the names of John R. Fredlund, Steven C. Sitter, William G. Peters, David C. Smart, which is hereby incorporated by reference herein.

Reference is made to commonly assigned, co-pending U.S. patent application Ser. No. ______, [Attorney Docket No. 87294], entitled: DATA FRAME HAVING DATABASE ACCESS INFORMATION, filed Dec. 22, 2004, in the names of Steven Sitter, John Fredlund, David Hodder; which is hereby incorporated by reference herein.

### FIELD OF THE INVENTION

The invention relates generally to the field of photofinishing, and in particular to customized or specialized photofinishing. More specifically, the invention relates to a methods and systems, in which the use of multiple data frames in a film unit is based on chronology of capture.

### BACKGROUND OF THE INVENTION

Photofinishing of photographic film can be provided by many different techniques depending upon the nature of the photographic film used and the desired output. It is convenient to define techniques by what are sometimes referred to as “photofinishing channels”. The term “photofinishing channel”, as used herein, refers to a predetermined photofinishing procedures for producing a final image that is output to a user. A particular channel can be analog, both analog and digital, or digital. For example, some photofinishing channels differ by the chemistry of the type of film that is photofinished in that channel. With film types such as Type 135 (35 mm), the photofinishing channel is indicated by a DX code that is provided on the outside of the film cartridge. In digital photofinishing, a particular photofinishing channel is provided by selection of a particular output path.

Subchannels can be provided within each channel. Subchannels differ in features of chemical processing, digital processing or both relative to a default feature set. Subchannels are optionally available to a user, by taking a particular action. If no subchannel is selected by a user, a default subchannel is provided by the photofinishing. A subchannel can provide modified digital processing or any other goods and/or services. Examples of actions providing particular photofinishing subchannels include: writing “push” or “pull” on a film processing envelope, purchasing a one-time use camera with included CD preparation, and selecting black-and-white when a set of digital images is submitted for digital printing.

Photofinishing of digital images on memory units is comparable to the photofinishing of film, particularly when the images are input to a system for later delivery without further user interaction. For example, this applies to memory units input into a photofinishing minilab, without editing or other changes. The result is ordinarily the provision of output according to a default subchannel. A simple approach to accessing other subchannels would be desirable.

One approach to variable photofinishing is presented by the Advanced Photography System™, which provides for user selection of prints with different aspect ratios. This approach requires specialized cameras and other equipment and provides a limited and fixed variety of different outputs.

Another approach, disclosed in U.S. Patent Application Publication No. US 2003/0090572, to Belz et al., is use of a specialized digital file to transmit subchannel information. This approach also requires use equipment that can create the file.

U.S. Pat. No. 6,311,018, to Lawther, proposes a method in which a DX code indicates that a particular roll of film is intended for both a particular channel for chemical processing and a particular subchannel that provides prints in multiple formats, such as pseudo panoramic and pseudo zoom. A camera with the multiple format capability places a second code within the image area of individual image frames to indicate which pseudo format print is desired for an individual frame. The photofinisher reads the DX code indicating both the film channel and the subchannel and then reads the codes for each frame. The code selecting the particular format must be present in the image area of the particular frame, or that image will be printed as a standard full-frame image. A shortcoming of this approach is that the DX is limited to the particular subchannel and a special camera is required to apply the codes in the image frames.

U.S. Pat. No. 5,587,752, to Petruchik, discloses a film cartridge that uses a data frame, that is, an image frame having subchannel information, positioned near the trailer end of the filmstrip to designate a set of prerecorded images for compositing. This method uses a special camera to place marks on the film. These marks make selections from the prerecorded image set identified by the data frame. This method requires a specialized camera, but the data frame can be scanned by digital photofinishing equipment using the same scanner that is used for scanning other film frames.

U.S. Pat. No. 6,429,924, to Milch, is similar to Petruchik, but has a data frame in the form of an image of a pattern at each end of the filmstrip. The pattern, when scanned during photofinishing, indicates that metadata for individual frames is present within the portion of the filmstrip bearing the sequence of images.

U.S. Pat. No. 6,628,895, to Fredlund et al., discloses a method for capturing a single data frame on a film unit within a camera by photographing a card bearing information for the data frame. This approach is limiting in that the data frame, once captured, cannot be overridden without intervention in the photofinishing process, such as use of manual photofinishing.

It would thus be desirable to provide systems and methods, in which fulfillment information in a data frame of an image unit can be superceded during automatic digital photofinishing.

### SUMMARY OF THE INVENTION

The invention is defined by the claims. The invention, in broader aspects, provides a photographic processing method, in which an image unit is received. The image unit has a plurality of printable image frames including first and second data frames and a plurality of non-data frames. The data frames each having different, alternative fulfillment information. A bitstream is generated of the image frames. The bitstream includes a chronology or other ranking of the data frames. The data frames are extracted from the bitstream. The data frames are read. The highest ranked of the data frames is determined. Fulfillment of the non-data frames is provided responsive to the alternative fulfillment information of the highest ranked of the data frames.

It is an advantageous effect of the invention that an improved systems and methods are provided, , in which fulfillment information in a data frame of an image unit can be superceded during automatic digital photofinishing.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagrammatical view of an embodiment of the system.

FIG. 2 is a flow chart of an embodiment of the method.

FIG. 3 is a flow chart of another embodiment of the method.

### DETAILED DESCRIPTION OF THE INVENTION

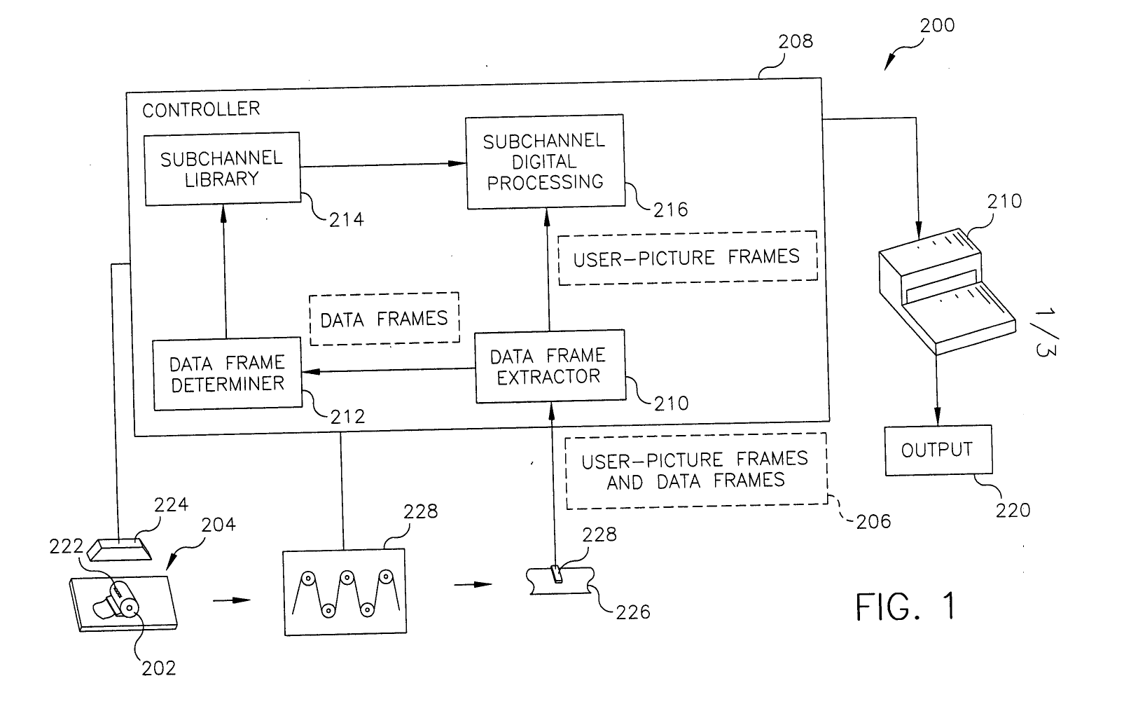

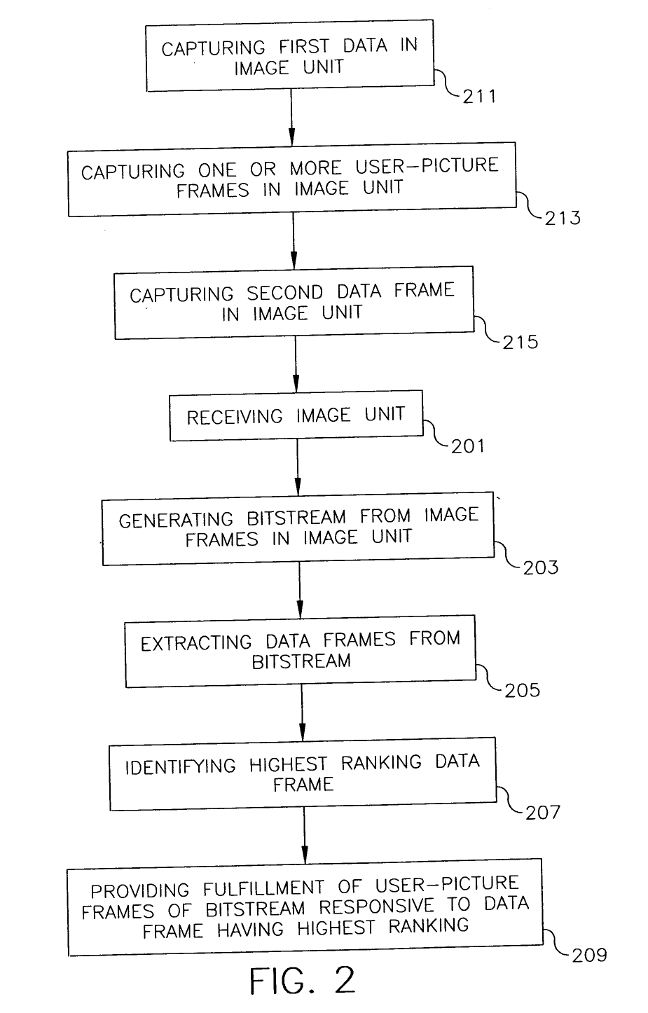

Referring to FIGS. 1-2, in the methods and system 200, an image unit 202 is received (201) at an entry station 204. The image unit 202 has printable image frames including a data frame and one or more non-data frames. The data frame includes database access information in the form of readable indicia. A bitstream 206 of the image frames is formed (203) and sent to a controller or control unit 208. The data frames are extracted (205) from the bitstream 206 by a data frame extractor 210, leaving the non-data frames. The data frames are sent to a data frame determiner 212, which identifies (207) the highest ranking data frame, such as the most recent of the data frames. A subchannel library 214 is accessed, and the subchannel indicated by the highest ranking data frame is applied to the non-data frames to provide (209) a data frame subchannel 216, in accordance with the subchannel information. The data frame subchannel is sent as instructions to an output device 210 (illustrated as a printer) and the output 220 is provided. Printing or other fulfillment of the data frame is, preferably, suppressed automatically. The same system provides fulfillment of image frames in image units lacking the indicator or having an unreadable indicator, in accordance with a default subchannel (not illustrated).

If the image unit 202 is a film cartridge, channel information 222, such as a DX code, is detected on a photographic film image unit 202 using a detector 224. The channel information is sent to the controller or control unit 208. The filmstrip 226 of the film unit 202 is chemically processed in a development unit 228, in accordance with the channel information. The developed filmstrip 226 is scanned with a scanner 228 and the bitstream 206 of images is sent to the controller 208, which provides fulfillment instructions for the image frames. The system 200 can have a reader (not illustrated), which can be used with a digital image unit to produce like results.

The data frames and non-data frames are captured before the image unit is received (201) for photofinishing. The order of capture is not critical, but it is convenient to capture (211) a first data frame, then capture (213) user-picture frames, and then capture (215) a second data frame. There is no upper limit on the number of data frames in an image unit, but it is consideration that each data frame takes up space as an image frame.

The method and apparatus relate to light images of scenes that have been captured in an image unit as image frames. The term “image unit” is used herein to refer to both film units and memory units. The film unit has a piece of film, such as a filmstrip, and, for some types of film unit, has a holder for the filmstrip. A memory unit includes computer readable digital storage media that provides digital memory for an electronic camera or other capture device. The form of the memory is not critical. For example, the memory can be optical, such as an optical CD or DVD, electronic such as a digital memory card; or magnetic such as magnetic tape.

The image unit has a plurality of frames. The term “frame” is used herein to refer to space within the image unit, which stores or is capable of storing a captured image. The term “image frame” is used herein to refer to image information that is or has been stored within a frame. The image information corresponds to a captured light image, is analog, in the case of photographic film, and can be in the form of a latent image (before chemical processing) or a visible image (following chemical processing). The image information is digital, in the case of a captured digital image stored as a digital file in a memory unit.

The image unit is generally discussed herein in terms of the same media being used for both capture and storage of archival image information. It should be understood that stored images may, in some cases, be transferred to a replacement medium one or more times. For example, an image unit can start out with the features of a one-time use photographic film camera. After film exposure, the camera body is removed; the filmstrip is removed from its canister and developed, and the film is scanned and the resulting digital images are stored in memory and digitally processed. Image frames captured with a digital camera are transferred from one type of digital memory to another, during photofinishing. The image frames of an image unit remain associated with each other at least through photofinishing.

The stored image frames are generally treated herein as being realistic images of the subject photographed and having the same, unchanging information content as the original light image. It will be understood that this is a simplification provided as a matter of convenience for explanatory purposes and that captured and stored image frames will differ from initially captured images in a manner well known to those of skill in the art. For example, the image frames must differ from the original light image, since the captured and stored image frames are subject to the limitations of the imaging system and the media. Film image frames are subject to limitations such as grain size. Digital image frames are necessarily pixellated and commonly have color values partially extrapolated from neighboring pixels. Both types of image frames may also be subject to enhancement or other modification between capture and output, for example, to extrapolate values for pixels degraded by sensor defects. Image frames on film are subject to the chemical and physical effects of processing. Image frames are generally stored in a non-realistic form, such as a film negative or a particular type of digital image file that requires modification to render the images viewable. Digital image frames must be displayed or printed and may require other modification, such as decryption or modification for a particular display device.

The image frame include “data frames” and “non-data frames”. The data frames are images of specific indicia that are readable by an expected photofinishing system. Other image frames are non-data frames. Generally, non-data frames are user-picture frames, which are images captured by a user of a camera for the purpose of obtaining a printed final image or a final image in some other form. The user is generally, but not always the end user. Other types of non-data frames are possible. For example, some high-end cameras optically write one or more image frames with image capture information, prior to film removal.

The term “photofinish” is used herein to refer to one or more physical, chemical, optical, and digital techniques used to produce a visible output, referred to here as a “final image”, which is a printed or displayed image or a digital image that is printable or displayable. Photofinishing thus includes such techniques as chemical development and digital image modification and printing. Photofinishing can be provided repeatedly for an image unit, but the repetitions may or may not repeat the same techniques. For example, an initial photofinishing of a photographic film type image unit will include chemical development. Later photofinishing of the same image unit will not. A “photofinishing system” is a device or group of locally or remotely linked devices providing a photofinishing function.

A data frame is an image frame and, thus, is printable as a hard copy image and displayable as a display image in the same manner as non-data frames. The data frame can be a photograph of a light image or, with a digital image unit, can be digitally generated. The data frame occupies space in the image unit that could otherwise be occupied by a non-data frame. The data frame is stored in the image unit and extracted from the image unit in the same manner as the non-data frames.

With film, the requirement that a data frame is or can be extracted from the image unit in the same manner as other images, localizes the data frame upon a filmstrip into the same area of the filmstrip as the images. For example, the data frame cannot be located outside or between perforations of the filmstrip. The data frame can be located on a leader or trailer, but only if that portion of the film strip can be reduced to final output, during photofinishing in the same manner as other images. With many types of film cameras each captured image is the same size, that is, all “storing” is a standard and uniform size within narrow limits. In such film camera types, a data frame is preferably the same size as an image frame. This can be varied. For example, some cameras can capture, both full and half frame images. In this case, a data frame can be either size.

In a digital image unit, a data frame is provided as a printable/displayable digital image file. The data frame in digital memory has the same size constraints as other image files. The data frame is not limited to a particular resolution, but typically the data frame is the same size as one or more of the other image files in an image unit. Storage space in the image unit can be saved, if a data frame is stored at the minimum resolution necessary for reading the data frame, within the limits of image capture of a particular camera or other capture device. In that case, non-data frames will likely be captured and stored at a higher resolution than the data frame. A header of an image file that contains image related information, but is not itself an image; is also not a data frame. It is preferred that a digital data frame be capable of undergoing digital processing in the same manner as associated images. For example, if image frames in a digital image unit are expected to be subject to lossy compression/decompression, then the data frame is configured so as to be capable of surviving the same lossy compression/decompression without unacceptable degradation in the same manner as non-data frames.

A data frame differs from the Digital Print Order File described in U.S. Patent Application Publication No. US 2003/0090572, in that a data frame is stored and printable as an image, and takes the place of a non-data frame. A Digital Print Order File or the like is not stored or printable as an image in the same manner as other image frames.

The data frame can be captured in the same manner as other image frames. In other words, photosensitive media, such as an electronic imager or photographic film, is exposed to a light image of the data frame. The light image can be provided by a transmission or reflection print or a display of the data frame content. With digital image units, the data frame can be digitally created.

Capture of the data frame can be before, during, or after capture of non-data frames. (Capture of the data frame after capture of non-data frames, is not preferred if there is a risk that the image unit will lack adequate storage space.) The data frame can be captured by anyone in possession of the image unit at a particular time. For example, the manufacturer can capture the data frame during manufacture, a distributor or dealer can capture a data frame prior to transfer of the image unit to an end user. The end user can also capture the data frame. The data frame can also be captured as an initial part of the photofinishing process.

The data frame content can be presented to a user in a form that allows the user to capture the content and, thus, create the corresponding data frame. The size of data frame content is a function of the environment in which the data frame content is presented and the features of the camera or other capture device used to capture the data frame. (For convenience, image capture in the following is discussed in relation to cameras.) For example, data frame content can be presented on small media, such as a card, held close to a camera or on large media farther away, such as a poster or billboard that is photographed at a distance. To make capture easier, fiducials or other features can be provided, which allow the photographer to more easily align the data frame content in the viewfinder of the camera. It may be necessary to provide other features, such as adequate lighting for image capture in a dark environment.

Depending upon how a picture is taken, the data frame content can occupy all or only part of the data frame. It is preferred that the data frame content occupy most or, more preferably, all of the data frame. This prevents user-pictures that include a data frame as incidental content from being treated as data frames. The size and nature of the data frame content can be varied to meet particular size requirements in the data frame and other limitations, such as limits on close focusing by particular cameras. For example, convenient data frame content for capture by a simple point-and-shoot camera is sized to provide a light image at three to six feet that fills the viewfinder (and the image frame). An example of a fixture for the capture of data frames using a one-time-use camera is disclosed in U.S. Pat. No. 6,628,895, which is hereby incorporated herein by reference.

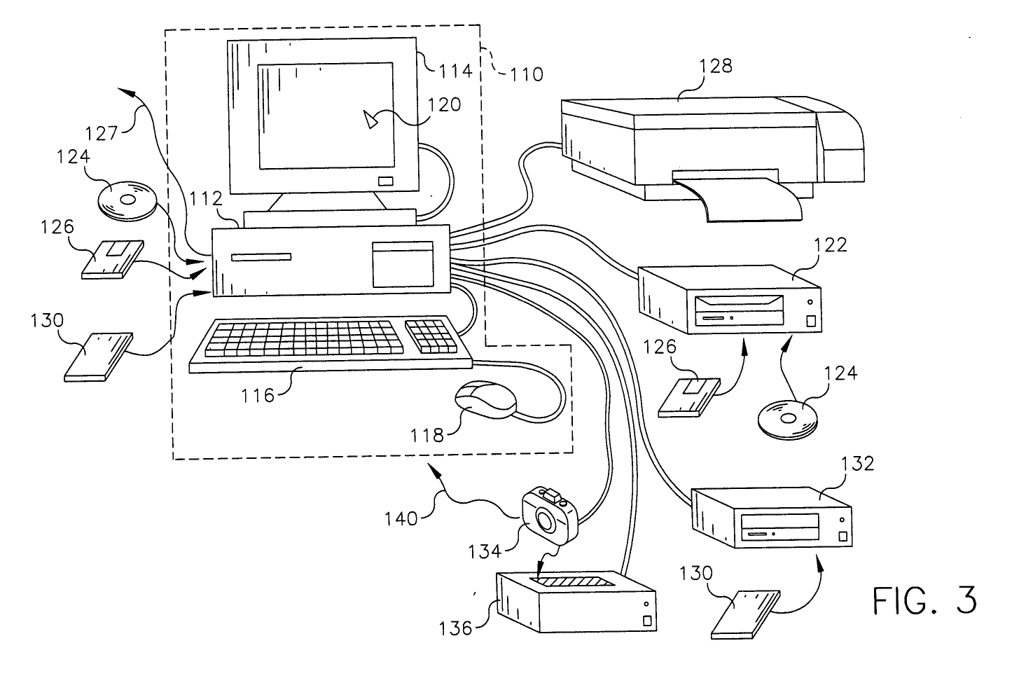

FIGS. 1 and 3 illustrate photofinishing systems for film and digital image units. The systems include a bitstream generator, which generates a bitstream of the image frames, and a controller or microprocessor based unit, which receives the bitstream from the bitstream generator and processes the bitstream to provide output as final images. In the film based system, channel information, such as a DX code is detected on the film unit at an entry station. The channel information is sent to the controller. The filmstrip is extracted (not shown) and chemically processed in a development unit, in accordance with the channel information. The developed filmstrip is scanned and sent to the controller. The controller has the separate subunits: data frame extractor, data frame determiner, subchannel library, and subchannel digital processing unit. The controller can include one or more programmed microprocessors and can be provided in one or more locally or remotely connected components. The indicated subunits can be provided logically. The data frame extractor extracts the data frames from the bitstream. The remainder of the bitstream is sent to the subchannel digital processing unit. The data frames are sent to the data frame determiner in a manner indicating relative chronology. The determiner determines applicable alternative and ancillary fulfillment information and accesses a library, which provides corresponding fulfillment instructions to the subchannel digital processing unit. Fulfillment results are sent to an output device and then provide as final image output.

The controller sends the image frames to a printer or other output device, which provides final images of all or the image frames as output. The printer outputs printed images of all of the image frames. The term “final images” is used herein to refer collectively to printed images, displayed images, and displayable and printable images recorded in digital media, such as a CD-ROM or DVD, that is transferred to the user who submitted the image unit.

The digital photofinishing system is illustrated, in FIG. 3, by a personal computer system 110. Although the computer system 110 is shown for the purpose of illustrating a preferred embodiment, the present invention is not limited to the computer system 110 shown, but may be used on any electronic processing system such as found in digital cameras, home computers, kiosks, retail or wholesale photofinishing, or any other system for the processing of digital images. The computer system 110 includes a microprocessor-based unit 112 (also referred to herein as a digital image processor) for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a means of inputting the software programs and other information to the microprocessor based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into externally located disk drive unit 122, which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images may also be displayed on the display 114 via a personal computer card (PC card) 130, such as, as it was formerly known, a PCMCIA card (based on the specifications of the Personal Computer Memory Card International Association), which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images stored in the PC card 130, the floppy disk 126 or the compact disk 124, or input through the network connection 127, may have been obtained from a variety of sources, such as a digital camera (not shown) or a scanner (not shown). Images may also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

The output device provides a final image that has been subject to transformations. The output device can be a printer or other output device that provides a paper or other hard copy final image. The output device can also be a display output device that provides the final image as a softcopy final image. The output device can also be an output device that provides the final image as a digital file. The output device can also include combinations of output, such as a printed image and a digital file on a memory unit, such as a CD or DVD.

The present invention can be used with multiple capture devices that produce digital images. For example, FIG. 3 can represent a digital photofinishing system where the image-capture device is a conventional photographic film camera for capturing a scene on color negative or reversal film, and a film scanner device for scanning the developed image on the film and producing a digital image. The capture device can also be an electronic capture unit (not shown) having an electronic imager, such as a charge-coupled device or CMOS imager. The electronic capture unit can have an analog-to-digital converter/amplifier that receives the signal from the electronic imager, amplifies and converts the signal to digital form, and transmits the image signal to the microprocessor-based unit 112.

The microprocessor-based unit 112 provides the means for processing the digital images to produce pleasing looking images on the intended output device or media. The present invention can be used with a variety of output devices that can include, but are not limited to, a digital photographic printer and soft copy display. The microprocessor-based unit 112 can be used to process digital images to make adjustments for overall brightness, tone scale, image structure, etc. of digital images in a manner such that a pleasing looking image is produced by an image output device. Those skilled in the art will recognize that the present invention is not limited to just these mentioned image processing functions.

A digital image includes one or more digital image channels or color components. Each digital image channel is a two-dimensional array of pixels. Each pixel value relates to the amount of light received by the imaging capture device corresponding to the physical region of pixel. For color imaging applications, a digital image will often consist of red, green, and blue digital image channels. Motion imaging applications can be thought of as a sequence of digital images. Those skilled in the art will recognize that the present invention can be applied to, but is not limited to, a digital image channel for any of the herein-mentioned applications. Although a digital image channel is described as a two dimensional array of pixel values arranged by rows and columns, those skilled in the art will recognize that the present invention can be applied to non rectilinear arrays with equal effect. Those skilled in the art will also recognize that for digital image processing steps described hereinbelow as replacing original pixel values with processed pixel values is functionally equivalent to describing the same processing steps as generating a new digital image with the processed pixel values while retaining the original pixel values.

The general control computer shown in FIG. 3 can store implementing programs in a computer readable storage medium, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM). The associated computer program implementation may also be stored on any other physical device or medium employed to store a computer program indicated by offline memory device.

It should also be noted that the present invention can be implemented in a combination of software and/or hardware and is not limited to devices, which are physically connected and/or located within the same physical location. One or more of the devices illustrated in FIG. 3 can be located remotely and can be connected via a network. One or more of the devices can be connected wirelessly, such as by a radio-frequency link, either directly or via a network.

The present invention may be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, printed on hard-copy prints, or soft copy display), kiosks (digital or scanned input, digital processing, digital or hard copy output, or soft copy display), mobile devices (e.g., PDA or cell phone that can be used as a processing unit, a display unit, or a unit to give processing instructions), and as a service offered via the World Wide Web.

In each case, the invention may stand alone or may be a component of a larger system solution. Furthermore, human interfaces, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject the result, or may be assisted by metadata (metadata that may be user supplied, supplied by a measuring device (e.g. in a camera), or determined by an algorithm). Moreover, the algorithm(s) may interface with a variety of workflow user interface schemes.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art.

The photofinishing system can provide subchannels in an almost unlimited variety. Fulfillment options provided by these subchannels can generally be roughly divided into three categories: remedial efforts, image alterations, and provision of additional goods and/or services. Remedial efforts are directed towards retaining the original information content, but improving the perceived quality of an image. Image alterations deliberately modify some of the original information content of an image. Table 1 lists some examples of fulfillment options.

TABLE 1

Optical distortion correction
Lateral color optical defect correction
Edge sharpening
Contrast correction
Color saturation correction
Improve grain, contrast, and color in underexposed pictures
Latitude improvement
Visible grain/noise reduction
Improve color accuracy/gamut remapping
Zooming and cropping
Intentional distortion
Solid color fill
Soft focus effects
Contrast exaggeration or reduction
Monochrome (black-and-white, sepia)
Redeye removal
Texture effects
Print only outlines
Add predetermined titles or logos to front or back
Solarization effects
Special borders or other photomontage
Add Copyright message
Sticker prints
Poster prints
Double prints
Selected paper surface finish
Selected digital medium
Stock photo or promotional item with order
Changes in delivery, billing, or follow on services

Fulfillment options can be implemented in any manner appropriate for the particular product and/or service provided. For example, a particular fulfillment option can be provision of automatic compensation for the bluish cast seen in underwater photographs. This type of finishing is marketed by the Eastman Kodak Company of Rochester, N.Y. as Sea Processing™. Sea Processing of an image unit applies algorithms that improve the appearance of pictures captured underwater, while leaving pictures taken above water unchanged. In this case, the algorithm is automatically applied as needed, following reading of the subchannel information. As another example, the subchannel can be provision of a poster of a stock photo. In this case, the implementation of the subchannel can include communication of information to an operator, who then provides a required function.

The indicia of the data frame identify a photofinishing subchannel that includes one or more fulfillment options. The indicia can be in any form that is readable by the photofinishing unit. For example, the indicia can be optically readable alphanumeric text and/or an encodement such as a two- or three-dimensional barcode. Examples of useful barcodes for this purpose and associated methods are disclosed in U.S. Pat. No. 6,456,798, to Keech et al., which is hereby incorporated herein by reference. The data frame can include one item of fulfillment information or multiple items. The indicia can repeat fulfillment information in the same or different forms, such as a barcode and optically readable text. Multiple layers of encryption can be used. Encodement information can be hidden within the data frame steganographically, so as to not be visible to casual examination. Appropriate methods and apparatus for preparation and use of all of these forms of encodements are well-known to those of skill in the art. In addition to the indicia, the data frame can include other functional or decorative features, for example, a decorative image can be provided, which may or may not relate to the subchannel indicated by the data frame. The data frame can also be reconstructed from the original extraction to a form that is similar to the particular output fulfillment. For example, the data frame can be scaled to better suit a particular output option or corrections can be made for processing losses.

The plurality of data frames in an image unit are “ranked”, that is, the data frames have a preselected characteristic that determines an order. The particular characteristic used is either predetermined for a particular photofinishing system or communicated to the photofinishing system by one or more of the data frames. The ranking, once defined, is automatically assigned, during photofinishing. A convenient ranking is chronological order of capture of the data frames. This can be readily determined by time/data metadata, automatically assigned file names, order within the image unit, or the like.

Referring now to FIG. 1, in the method, an image unit is received for photofinishing. The image unit has a plurality of printable image frames, including first and second data frames and a plurality of non-data frames. Each of the data frames has different, alternative fulfillment information. A bitstream is generated from the image frames in the image unit. The bitstream includes a chronology of the data frames. The data frames are extracted and read. The most recently captured data frame is determined from the chronology. The photofinishing provides fulfillment of the non-data frames of the bitstream responsive to the alternative subchannel information of the most recently captured of the data frames.

The image unit has two or more different data frames. Each of the data frames has fulfillment information in the form of indicia. The fulfillment information on the data frames of the image unit is alternative or ancillary. The term “alternative fulfillment information” is used here to refer to two or more items of fulfillment information that can only be provided as alternatives. For example, with a particular photofinishing system,—print black-and-white—and —print saturated color—are a pair of alternative fulfillment options. The term “ancillary fulfillment information” is used herein to refer to two or more items of fulfillment information that can be provided at the same time. Continuing the above example,—all prints glossy finish—is ancillary fulfillment information when presented in combination with either or both:—all prints black-and-white—and —all prints saturated color—. Each data frame can have more than one item of fulfillment information.

Whether a particular item of fulfillment information is alternative or ancillary is determined by the combination of data frames present in an image unit and the characteristics of a particular photofinishing system. For example, a particular photofinishing system may be limited to satin finish on black-and-white prints. For that photofinishing system,—print black-and-white—and—print glossy finish—are alternative, rather than ancillary. Possible fulfillment options and whether combinations of those options are alternative or ancillary is predetermined for a particular photofinishing system.

The data frames are extracted from the bitstream using an algorithm that recognizes required features of the data frame. Extraction of the access information can be based upon optical character recognition or barcode recognition or the like. Suitable techniques for this purpose are well known to those of skill in the art. Provisions can be made to help limit application of such techniques to only the data frame. For example, a data frame can be required to have particular values in one or more predefined windows of the image frame. A shape recognition algorithm can be used for detection of one or more features present in the data frames. The features can be chosen so as to render misidentification unlikely. A example of a suitable algorithm for particular features is disclosed in U.S. Pat. No. 6,741,326, which is hereby disclosed herein by reference.

The number of data frames in the image unit is two or more. There is no upper limit, other than that the image unit include one or more user-picture frames or other non-data frames. Each data frame is captured at a different time. Capture of the data frames can be before, during, or after capture of user-picture frames. (Capture of one or more of the data frames after capture of user-picture frames, is not preferred if there is a risk that the image unit will lack adequate storage space.) The data frames can be captured by anyone in possession of the image unit at a particular time. For example, the manufacturer can capture one or more data frames during manufacture; likewise, a distributor or dealer can likewise capture one or more data frames prior to transfer of the image unit to an end user. The end user can also capture one or more data frames.

The motivation for the capture of multiple data frames is to change and/or add to currently chosen fulfillment options. This can allow a manufacturer to provide a number of different products, by simply adding a data frame providing appropriate fulfillment information. A consumer is not constrained by the manufacturer's choice and can keep an existing fulfillment choice or change it, as desired. For example, a retailer records a data frame with the fulfillment option—two sets of satin finish 4×6 prints for the price of one—on a new memory unit or a memory unit returned from photofinishing. The user wants sticker prints and therefore photographs a data frame with indicia for that fulfillment option. In a particular photofinishing system, the two data frames present alternative fulfillment information. The fulfillment option of the most recently captured data frame is provided and the earlier fulfillment option is overridden.

The most recently captured data frame is determined from a chronology included in the bitstream of image frames. The chronology can be in the form of metadata, such as date/time information recorded at the time of image capture or can be limited to information that indicates the sequence of image frames, as captured. The latter can be indicated by digital file names or even by relative placements of image information in the bitstream.

An alternative method of applying multiple mutually exclusive subchannels can be employed via recording multiple data frames within an image unit. A first subchannel applies to image frames until a second subchannel is detected, at which time the first subchannel is superceded by the second. The image frames following the second subchannel data frame are subject to the second subchannel. The notion of following may entail position in the case of analog capture, or later in time for digital images with time stamps in headers or ascending image numbers.

The fulfillment can include printing or other preparation of the data files as final images, but this is ordinarily undesirable, since the data frames are not a desired output for a user. The fulfillment of the data frames can, therefore, be precluded during photofinishing.

The invention has been described in detail with particular reference to certain preferred embodiments thereof, but it will be understood that variations and modifications can be effected within the spirit and scope of the invention.

What is claimed is:

1. A photographic processing method comprising the steps of:
receiving an image unit having a plurality of printable image frames, said image frames including ranked first and second data frames and a plurality of non-data frames, said data frames each having different, alternative fulfillment information;
generating a bitstream of said image frames;
extracting said data frames from said bitstream;
reading said data frames to provide first and second fulfillment instructions;
determining a rank order of said data frames;
providing fulfillment of said non-data frames in accordance with said fulfillment information and in accordance with said rank order.

2. The method of claim 1 wherein said image frames include a chronology.

3. The method of claim 2 wherein said providing further comprises fulfilling said non-data frames in accordance with the immediately preceding data frame.

4. The method of claim 1 wherein said providing further comprises fulfilling all of said non-data frames responsive to said alternative fulfillment information of said highest ranked of said data frames.

5. The method of claim 1 further comprising precluding fulfillment of said data frames.

6. The method of claim 1 wherein said ranking is a chronology.

7. The method of claim 6 wherein one or more of said data frames have ancillary fulfillment information and said providing fulfillment is responsive to said alternative fulfillment information of the most recently captured of said data frames and to all of said ancillary fulfillment information.

8. The method of claim 1 wherein one or more of said data frames have ancillary fulfillment information and said providing fulfillment is responsive to said alternative fulfillment information of said most recently captured of said data frames and to all of said ancillary fulfillment information.

9. The method of claim 8 wherein said image unit has more than two data frames, including said first and second data frames, and at least two of said data frames include said alternative fulfillment information.

10. The method of claim 1 further comprising capturing one of said data frames, then capturing one or more non-data frames, then capturing another of said data frames.

11. The method of claim 10 wherein each said data frame is optically captured.

12. The method of claim 1 further comprising automatically excluding said data frames from said fulfillment.

13. The method of claim 1 wherein said image unit includes photographic film, said image frames are latent images recorded on said film, and said generating further comprises:
chemically developing said latent images to provide visible images; and
scanning said visible images.

14. The method of claim 1 wherein said image unit includes digital memory and said generating further comprises reading said memory.

15. The method of claim 1 wherein said data frames are the same size as one or more of said non-data frames.

16. The method of claim 1 further comprising vending said image unit after capturing said first data frame and before capturing said second data frame.

17. A photographic processing method comprising the steps of:
receiving an image unit having a plurality of printable image frames, said image frames including first and second data frames and a plurality of non-data frames, said data frames each having different, alternative fulfillment information;
generating a bitstream of said image frames;
extracting said data frames from said bitstream;
reading said data frames;
providing fulfillment of at least one non-data frame of said bitstream responsive to said alternative fulfillment information of said first of said data frames; and
providing fulfillment of at least one non-data frame of said bitstream responsive to said alternative fulfillment information of said second of said data frames.

18. The method of claim 17 wherein said bitstream includes a ranking of said data frames and said providing fulfillment steps are responsive to said ranking.

19. The method of claim 18 wherein said ranking is chronological.

20. A system for photographically processing an image unit having a plurality of image frames including first and second data frames and a plurality of user-picture frames, said first and second data frames being ranked, said data frames having different, alternative fulfillment information, said system comprising:
a bitstream generator capable of generating a bitstream of said image frames;
a control unit receiving said bitstream from said bitstream generator, said control unit extracting said data frames from said image frames of said bitstream, said control unit ignoring said first data frame, said control unit issuing fulfillment instructions responsive to said alternative fulfillment information in said second data frame.

21. The system of claim 20 wherein said alternative fulfillment information include digital processing of said user-picture frames in accordance with said data frame.

22. The system of claim 21 wherein said control unit suppresses fulfillment of said data frames.

23. The system of claim 20 wherein one or more of said data frames have ancillary fulfillment information and said fulfillment instructions are responsive to said alternative fulfillment information of said most recently captured of said data frames and to all of said ancillary fulfillment information.
